(19) United States
(12) Patent Application Publication
(10) Pub. No.: US 2025/0034402 A1
(43) Pub. Date: Jan. 30, 2025

(54) METALLIC PIGMENT COMPOSITION

(71) Applicant: ASAHI KASEI KABUSHIKI KAISHA, Tokyo (JP)

(72) Inventors: Shintaro FUKUHARA, Tokyo (JP); Hiroyuki KOMAKINE, Tokyo (JP)

(73) Assignee: ASAHI KASEI KABUSHIKI KAISHA, Tokyo (JP)

(21) Appl. No.: 18/716,709

(22) PCT Filed: Dec. 22, 2022
(86) PCT No.: PCT/JP2022/047384

§ 371 Date: Jun. 5, 2024

(30) Foreign Application Priority Data
Dec. 28, 2021 (JP) 2021-213842

(51) Int. Cl. C09C 3/12; C09C 1/64

(52) U.S. Cl. CPC C09C 3/12; C09C 1/644; C01P 2006/90

(57) ABSTRACT

Provided are a metallic pigment composition endowed with high water resistance as well as exceptional optical properties and water dispersibility, and a novel method for producing the metallic pigment composition. The present invention is a metallic pigment composition containing metal particles of which the surface is coated with a polysiloxane compound, the metallic pigment composition characterized in that the surface roughness R a is 0.0-2.0 nm when the roughness of the polysiloxane compound layer present on the particle surface is evaluated by AFM.

### TECHNICAL FIELD

The present invention relates to a metallic pigment composition suitable for, for example, a paint composition or an ink composition, in particular, an aqueous paint or an aqueous ink, and a method for producing the same.

### BACKGROUND ART

A metallic pigment composition has conventionally been used for a metallic paint, a printing ink, plastic kneading, and the like to obtain a beautifying effect that focuses on metallic feeling. In the paint field, there is a growing need for the shift to an aqueous paint using a low amount of organic solvent, as a resource saving measure and a pollution-free measure, in recent years; however, there are still a few examples of practicable aqueous paints in the metallic paint containing metallic pigment powder. The reason for this is that metallic pigment powder is easily corroded in an aqueous paint. When metal powder is present in an aqueous paint, corrosion by water occurs at any of acidic, neutral, and basic regions or a plurality of regions based on the properties of various metals, so that hydrogen gas is generated. This is a significantly serious problem for safety in the production process of a paint and an ink in paint manufacturers and ink manufacturers, and the coating process and printing process in automobiles, home appliances manufacturers, printing manufacturers, and the like.

Patent Document 1, which belongs to a field different from that of the metallic pigment for an aqueous paint, discloses an aluminum pigment composition whose surface is coated with fine organic polymer particles and describes that a smooth coated layer allows optical properties to be easily exerted.

Patent Document 2 discloses that an aluminum pigment having excellent optical properties can be obtained by controlling the surface roughness Ra of aluminum pigment particles to a specific range. However, the Ra in this Patent Document is equivalent to the evaluation of the strain of the particles themselves.

Although Patent Documents 3 and 4 disclose a method for coating a metallic pigment with a polysiloxane compound obtained by synthesis using a basic compound such as ammonia or an amine compound, the loss of optical properties before and after hydrophilization treatment, that is, deterioration in color tone is not suppressed.

### PRIOR ART DOCUMENTS

### Patent Document

Patent Document 1: JP 2019-203143 A
Patent Document 2: Japanese Patent No. 3714872
Patent Document 3: JP 2019-151678 A
Patent Document 4: Japanese Patent No. 3948934

### SUMMARY OF INVENTION

### Technical Problem

An object of the present invention is to provide a metallic pigment composition having high water resistance, and excellent optical properties and water dispersibility, and a novel production method thereof.

A further object of the present invention is to provide a metallic pigment composition that is usable for, for example, a paint composition or an ink composition, in particular, an aqueous paint or an aqueous ink, excellent in the storage stability as the paint or the like, and also excellent in optical properties such as brightness and hiding properties when used as a coating film, and a novel production method thereof.

Based on the fact that the aluminum pigment composition having a smooth, organic polymer-coated layer disclosed in Patent Document 1 exerts optical properties, the present inventors have considered that the effect can also be applied to metal particles whose surface is coated with another compound. That is, the present inventors have contemplated to improve the color tone by smoothing a polysiloxane compound layer in metal particles coated with a polysiloxane compound. As a result of various examinations, the present inventors have succeeded in forming a polysiloxane compound coated layer that is smoother than that of conventional techniques.

Further, the present inventors have also succeeded in allowing particles having a smooth particle surface and particles having a rough particle surface to coexist by forming a smooth polysiloxane compound on the surface of the metal particles, and then partially changing it to a rough layer. Thus, the present inventors have found that not only high optical properties and water resistance, but also high water dispersibility is exhibited, thereby completing the present invention.

### Solution to Problem

The present invention is as follows.

[1]

A metallic pigment composition comprising metal particles whose surface is coated with a polysiloxane compound, wherein a surface roughness Ra when roughness of a polysiloxane compound layer present on the surface of the particles is evaluated by AFM is 0.0 to 2.0 nm.

[2]

The metallic pigment composition comprising metal particles whose surface is coated with a polysiloxane compound according to [1], wherein a standard deviation of average values when roughness of the polysiloxane compound layer present on the surface of the particles is evaluated by AFM for 20 particles is 1.0 or less.

[3]

The metallic pigment composition according to [1] or [2], wherein the polysiloxane compound coating the surface of the metal particles is present in an amount of 0.1 to 50 parts by mass with respect to 100 parts by mass of the metal particles, in the metallic pigment composition.

[4]

The metallic pigment composition according to any of [1] to [3], wherein a silicon-containing compound forming the polysiloxane compound layer is at least one selected from the group consisting of alkoxysilane represented by the following general formula (1), tetrahalosilane represented by the following general formula (2), silane coupling agents of the following general formulas (3) to (5), and a partial condensate thereof:

Si(OR¹)₄ (1)
wherein R¹ is a hydrogen atom or a hydrocarbon group having 1 to 8 carbon atoms, and all R¹ are optionally the same, some R¹ are optionally the same, or all R¹ are optionally different;

SiX¹₄ (2)
wherein X¹ is any one of a fluorine atom, a chlorine atom, a bromine atom, and an iodine atom, and all X¹ are optionally the same, some X¹ are optionally the same, or all X¹ are optionally different;

R²ₘSi(OR³)₄₋ₘ (3)
wherein R² is a hydrogen atom or a hydrocarbon group having 1 to 30 carbon atoms and optionally containing a heteroatom or a halogen group, R³ is a hydrogen atom or a hydrocarbon group having 1 to 8 carbon atoms; R² and R³ are optionally the same or different; all R² or R³ are optionally the same, some R² or R³ are optionally the same, or all R² or R³ e optionally different when two or more R² or R³ are present; and 1≤m≤3 is satisfied;

R⁴ₚR⁵_{q}Si(OR⁶)_{4-p-q} (4)
wherein R⁴ is a group containing a reactive group capable of chemically bonding with another functional group, R⁵ is a hydrogen atom or a hydrocarbon group having 1 to 30 carbon atoms and optionally containing a halogen group, and R⁶ is a hydrogen atom or a hydrocarbon group having 1 to 8 carbon atoms; all R⁴, R⁵, or R⁶ are optionally the same, some R⁴, R⁵, or R⁶ are optionally the same, or all R⁴, R⁵, or R⁶ are optionally different when two or more R⁴, R⁵, or R⁶ are present; and 1<p<3, 0≤q≤2, and 1<p+q≤3 are satisfied; and

R⁷,SiX²⁴-r (5)
wherein R⁷ is a hydrogen atom or a hydrocarbon group having 1 to 30 carbon atoms and optionally containing a heteroatom or a halogen group, R⁷ are optionally the same or different, and all R⁷ are optionally the same, some R⁷ are optionally the same, or all R⁷ are optionally different when two or more R⁷ are present; 1≤r≤3 is satisfied; X² is any one of a fluorine atom, a chlorine atom, a bromine atom, and an iodine atom, and all X² are optionally the same, some X² are optionally the same, or all X² are optionally different when two or more X² are present.
   [5]

A method for producing the metallic pigment composition according to any of [1] to [4], comprising subjecting a silicon-containing compound to hydrolysis and condensation reaction in an organic solvent with a carbonate compound having a solubility in 100 g of water at ordinary temperatures of 20 g/100 g water or more in an amount of 0.1 mol % or more and 30 mol % or less based on the silicon-containing compound to obtain a polysiloxane compound, and coating the surface of metal particles with the obtained polysiloxane compound.

[6]

A method for producing the metallic pigment composition according to any of [1] to [4], comprising subjecting the metal particles coated with the polysiloxane compound to reflux treatment in a hydrophilic solvent in the copresence of a basic compound and water.

[7]

The method for producing the metallic pigment composition according to [5], comprising subjecting the metal particles coated with the obtained polysiloxane compound to reflux treatment in a hydrophilic solvent in the copresence of a basic compound and water.

### Advantageous Effects of Invention

Metallic pigment particles having a smooth polysiloxane compound layer of the present invention are unlikely to impair brightness even in the case of containing a large amount of the polysiloxane compound. In addition, by optionally adding an additional treatment step, the surface of the polysiloxane compound layer of some particles can be partially roughened. This allows particles having a smooth polysiloxane compound layer and particles having a rough polysiloxane compound layer to coexist. These particles have a further high dispersibility, and can be easily dispersed to primary particles not only in a hydrophilic organic solvent, but also in water. The metallic pigment composition of the present invention having a smooth coated layer and exhibiting high dispersibility can exert excellent optical properties and high water resistance.

### BRIEF DESCRIPTION OF DRAWINGS

FIG. 1 illustrates a height image and a bird's-eye view of one field of view of the sample obtained in Example 1 observed by AFM.

FIG. 2 illustrates a height image and a bird's-eye view of one field of view of the sample obtained in Comparative Example 1 observed by AFM.

### DESCRIPTION OF EMBODIMENTS

Hereinafter, the present invention, in particular, preferred aspects thereof will be mainly described in detail.

The present invention is a metallic pigment composition containing metal particles whose surface is coated with a polysiloxane compound, wherein the surface roughness Ra of the polysiloxane compound layer present on the surface of the particles is 0.0 to 2.0 nm. The surface roughness Ra is preferably 0.1 to 2.0 nm, more preferably 0.2 to 2.0 nm, still more preferably 0.4 to 2.0 nm, yet more preferably 0.5 to 2.0 nm, and particularly preferably 0.6 to 2.0 nm.

### <Surface Roughness Ra of Polysiloxane Compound Layer>

The surface roughness Ra of the polysiloxane compound layer is measured by an atomic force microscope (AFM) under the following conditions. Regardless of the present invention or conventional techniques, the thickness of the polysiloxane compound layer present on the surface of a metal particle is smaller than the strain derived from the metal particle itself as a substrate. Thus, when the surface roughness Ra of the entire surface of the particle is measured using AFM, the shape characteristics including unevenness of the metal particle itself largely affect the value of Ra, and the roughness of the polysiloxane compound layer cannot be correctly evaluated.

Then, in the present invention, a particle observed in a 2 μm square is uniformly divided into 16 divisions, three-dimensional correction is carried out on each division, and Ra is calculated for each division. The minimum Ra value in 16 divisions is taken as Ra derived from the polysiloxane compound layer, and the minimum average value of 20 particles is taken as the surface roughness Ra of the polysiloxane compound layer present on the particle surface.

### <AFM Measurement>

Apparatus: Bruker Dimension Icon
Measurement mode: QNM in Air
Probe: SCANASYST-AIR (k=0.4 N/m, ozone cleaned one is used)
Measurement field of view: 2 μm/512×512 pixels

The measurement is carried out by cleaning a sample with hexane, and then attaching the sample to a silicon wafer surface. The measurement field of view is set to 2 μm, 512 pixels. The measurement field of view is divided into 16 divisions, three-dimensional correction (Plane Fit) is carried out on each division, and then, Ra values are calculated. The minimum value in 16 divisions is taken as Ra derived from the polysiloxane compound layer, and an average value of 20 fields of view is calculated for each sample.

By controlling the surface roughness Ra of the polysiloxane compound layer within a range of 0.0 to 2.0 nm, scattering when the metal pigment composition of the present invention reflects light as a bright pigment can be effectively suppressed, and deterioration in color tone can be effectively suppressed even when a large amount of the polysiloxane compound is contained. In addition, by controlling the surface roughness Ra within a range of 0.0 to 2.0 nm, the amount of gas generated in acidic (pH 5) and basic (pH 9) aqueous media can also be significantly suppressed. Gas generation in an aqueous medium is caused by the corrosion of the metal surface due to the acid or base entered from a tiny gap in the polysiloxane compound layer. Here, it is considered that controlling the surface roughness Ra of the polysiloxane compound layer to a specific value reduces the tiny gap into which the acid or base enters, which may result in an improvement in gas generating properties.

Meanwhile, to improve water dispersibility in addition to water resistance and color tone, the lower limit value of the surface roughness Ra of the polysiloxane compound layer is preferably set to at least 0.1 nm or more. When moderate unevenness remains on the polysiloxane compound layer, there is moderate room for entry of water, and there are tendencies that the bonding between particles is weakened and water dispersibility is improved.

Further, when the surface roughness falls within the range and the standard deviation in the evaluation of roughness of 20 particles is 1.0 or less, a metallic pigment composition having both high water resistance and excellent brightness characteristics can be obtained.

Above all, the metallic pigment composition containing particles having a standard deviation of 0 to 0.5 tends to be excellent in water resistance, and can retain high water resistance when the polysiloxane compound layer is thin.

Meanwhile, when the standard deviation is 0.5 to 1.0, the metallic pigment composition tends to exhibit further high hydrophilicity and can be easily dispersed to primary particles in water.

### <Method for Producing Metallic Pigment Composition>

The metallic pigment composition of the present invention contains polysiloxane compound-coated metal particles obtained by adding an aqueous solution of a carbonate compound having a solubility in 100 g of water at ordinary temperatures of 20 g/100 g water or more as a catalyst into an organic solvent, subjecting a silicon-containing compound to hydrolysis and condensation reaction to obtain a polysiloxane compound, and coating the surface of metal particles with the obtained polysiloxane compound. The surface of the metal particles is smoothly coated with the polysiloxane compound obtained by utilizing the hydrolysis and condensation reaction of the silicon-containing compound using the above catalyst. In addition, in the case of imparting further high water dispersibility, the metallic pigment composition can be obtained by changing the structure of the polysiloxane compound layer of some particles by refluxing the obtained coated particles in a hydrophilic organic solvent in the copresence of a basic compound and water.

As mentioned above, the metallic pigment composition of the present invention may be produced by combining a step of forming a smooth polysiloxane compound layer on the surface of metal particles and a step of subjecting the metal particles thus obtained to reflux treatment. As used herein, the former step is described as the “coating treatment” step, and the latter step is described as the “reflux treatment” step.

### <<Coating Treatment>>

The coating treatment step is a step of forming a polysiloxane compound layer on the surface of metal particles.

### <Coating Treatment Catalyst>

As the catalyst in the coating treatment step of the present invention, a carbonate compound having a solubility in 100 g of water at ordinary temperatures of 20 g/100 g water or more is used, which is added to the system as an aqueous solution. To easily control the amount of water mentioned below, a carbonate compound excellent in water solubility is suitable. Specific examples thereof include sodium carbonate (22), ammonium carbonate (25), potassium carbonate (112), rubidium carbonate (225), and cesium carbonate (260.5). Among them, rubidium carbonate and cesium carbonate which have high water solubility are preferable, and cesium carbonate which has further high solubility in the organic solvent is particularly preferable. The numeral in the parenthesis represents solubility (g/100 g water). Since cesium carbonate also has solubility in the organic solvent, cesium carbonate can be exceptionally added to the system in a solid form. Due to the excellent solubility of these carbonate compounds, the water to be used for the hydrolysis and condensation reaction of the silicon-containing compound can be reduced, and the corrosion of metal particles can be avoided. The catalytic amount of the carbonate compound is preferably 0.1 mol % or more and 30 mol % or less, and more preferably 0.1 mol % or more and 25 mol % or less based on the silicon-containing compound. When the catalytic amount is the lower limit of the range or more, sufficient catalyst activity can be obtained, and deterioration in color tone derived from the aggregation and enlargement of particles due to long-term contact with water of the metallic pigment in an uncoated state. When the catalytic amount is the upper limit of the range or less, the hydrolysis and condensation reaction of the silicon-containing compound can be maintained at a moderate speed, and aggregation between metal particles and deterioration in color tone can be prevented.

The preferred type of catalyst and the preferred catalytic amount are as mentioned above, and the method for obtaining the metallic pigment composition of the present invention is not limited to the aforementioned method. In short, what is important is to suppress the three-dimensional growth of the polysiloxane compound to be produced and to form a smooth polysiloxane compound layer, and the method for controlling the hydrolysis reaction and condensation reaction of the silicon-containing compound is not limited to the above.

### <Organic Solvent>

The coating treatment for obtaining the metallic pigment composition of the present invention is conducted in a state where the metal particles are dispersed in an organic solvent. The type of organic solvent is preferably a hydrophilic organic solvent, from the viewpoint of improving the reactivity of the silicon-containing compound with metallic pigment particles such as aluminum. The organic solvent is more preferably an alcoholic solvent, and still more preferably a secondary alcohol. Above all, examples of the particularly preferred secondary alcohol include isopropyl alcohol, 2-butanol, 2-pentanol, 3-pentanol, propylene glycol monomethyl ether, and propylene glycol monobutyl ether.

### <Water>

In the coating treatment step of obtaining the metallic pigment composition according to the present invention, the polysiloxane compound is synthesized by adding an aqueous solution containing the catalytic amount of the carbonate compound in the copresence of metal particles and thereby reacting the silicon-containing compound with water. At this time, from the viewpoint of avoiding metal corrosion, the water to be added is not particularly limited, but is preferably 0.5 to 4 molar equivalents, and still more preferably 1 to 4 molar equivalents based on the silicon-containing compound.

### <Metal Particles>

As the metal particles used in the present invention, particles of base metals such as aluminum, titanium, zinc, iron, magnesium, copper, nickel, and chrome, and particles of alloys thereof are preferably used. Among them, aluminum, titanium, nickel, and chrome are more preferable, and aluminum is particularly preferable.

As for the shape of the metal particles, the average particle size (d50) is preferably 2 to 20 μm, and the average thickness (t) is preferably in a range of 0.001 to 1 μm, and still more preferably in a range of 0.01 to 0.8 μm.

The metal particles used as the pigment are not particularly limited, but are preferably scaly particles.

The average particle size (d50) of the metal particles can be measured by the same method as the method described below with respect to the average particle size d50 of the coated particles contained in the aluminum pigment composition in Examples.

The average thickness (t) of the metal particles can be calculated from the water surface diffusion area and density of particles. The water surface diffusion area refers to an area occupied by dry composite particles per unit mass, when composite particles that are dried by utilizing a leafing phenomenon are uniformly diffused on a water surface to cover the water surface without clearances. The measurement of the water surface diffusion area can be carried out in accordance with the specification of JIS K5906:1998.

Particularly preferable are aluminum flakes that are frequently used as metallic pigments. As the aluminum flakes to be used in the present invention, those having surface properties such as surface glossiness, whiteness, and brightness; a particle diameter, and a shape that are required for a metallic pigment are suitable.

Aluminum flakes are usually commercially available in a paste state, and they may be used as they are, or may be used after the fatty acid and the like on the surface are removed with an organic solvent or the like, in advance. The powder of such aluminum flakes is typically obtained by grinding atomized aluminum powder and/or an aluminum foil in the presence of a grinding aid or an inert solvent by using a method commonly used in the pigment field, such as a dry ball mill method, a wet ball mill method, an attritor method, or a stamp mill method, to have a so-called scaly shape, and further performing necessary steps such as sieving (classification), filtration, washing, and mixing, after this step.

In another embodiment, a so-called aluminum vapor deposited foil having an average particle size (d50) of 3 to 30 μm and an average thickness (t) of 5 to 50 nm can also be used.

### <Silicon-Containing Compound>

As the silicon-containing compound used in the present invention, at least one selected from alkoxysilane represented by the following general formula (1), tetrahalosilane represented by the following general formula (2), silane coupling agents of the following general formulas (3) to (5), and a partial condensate thereof is preferably used.

Si(OR¹)₄ (1)
wherein R¹ is a hydrogen atom or a hydrocarbon group having 1 to 8 carbon atoms, and all R¹ are optionally the same, some R¹ are optionally the same, or all R¹ are optionally different.

SiX¹₄ (2)
wherein X¹ is any one of a fluorine atom, a chlorine atom, a bromine atom, and an iodine atom, and all X¹ are optionally the same, some X¹ are optionally the same, or all X¹ are optionally different.

R²ₘSi(OR³)₄₋ₘ (3)
wherein R² is a hydrogen atom or a hydrocarbon group having 1 to 30 carbon atoms and optionally containing a heteroatom or a halogen group (any one of a fluorine atom, a chlorine atom, a bromine atom, and an iodine atom), and R³ is a hydrogen atom or a hydrocarbon group having 1 to 8 carbon atoms; R² and R³ are optionally the same or different; all R² or R³ e optionally the same, some R² or R³ are optionally the same, or all R² or R³ are optionally different when two or more R or R³ are present; and 1≤m≤3 is satisfied.

R⁴ₚR⁵_{q}Si(OR⁶)_{4-p-q} (4)
wherein R⁴ is a group containing a reactive group capable of chemically bonding with another functional group, R⁵ is a hydrogen atom or a hydrocarbon group having 1 to 30 carbon atoms and optionally containing a halogen group, and R⁶ is a hydrogen atom or a hydrocarbon group having 1 to 8 carbon atoms; all R⁴, R⁵, or R⁶ are optionally the same, some R⁴, R⁵, or R⁶ are optionally the same, or all R⁴, R⁵, or R⁶ are optionally different when two or more R⁴, R⁵, or R⁶ are present; and 1≤p≤3, 0≤q≤2, and 1≤p+q≤3 are satisfied.

R⁷ᵣSiX²₄₋ᵣ (5)
wherein R⁷ is a hydrogen atom or a hydrocarbon group having 1 to 30 carbon atoms and optionally containing a heteroatom or a halogen group (any one of a fluorine atom, a chlorine atom, a bromine atom, and an iodine atom), R⁷ are optionally the same or different, and all R⁷ are optionally the same, some R⁷ are optionally the same, or all R⁷ are optionally different when two or more R⁷ are present; 1≤r≤3 is satisfied; X² is any one of a fluorine atom, a chlorine atom, a bromine atom, and an iodine atom, and all X² are optionally the same, some X² are optionally the same, or all X² are optionally different when two or more X² are present.

Examples of the hydrocarbon group in R¹ in the formula (1) include methyl, ethyl, propyl, butyl, hexyl, and octyl, which may be branched or linear. Among these hydrocarbon groups, methyl, ethyl, propyl, and butyl are particularly preferable. In addition, with respect to four R¹, all R¹ are optionally the same, some R¹ are optionally the same, or all R¹ are optionally different.

Preferred examples of such a silicon-containing compound (organic silicon compound) of the formula (1) include tetramethoxysilane, tetraethoxysilane, tetrapropoxysilane, tetraisopropoxysilane, and tetrabutoxysilane.

Examples of the hydrocarbon group in R² in the formula (3) include methyl, ethyl, propyl, butyl, hexyl, octyl, decyl, dodecyl, oleyl, stearyl, cyclohexyl, phenyl, benzyl, and naphthyl, which may be branched or linear, optionally contain a halogen group such as fluorine, chlorine, or bromine, and optionally contain a heteroatom such as nitrogen, oxygen, or sulfur. Among them, a hydrocarbon group having 1 to 18 carbon atoms is particularly preferable. In addition, when two or more R² are present, all R² are optionally the same, some R² are optionally the same, or all R² are optionally different. The number of R² in a molecule is m=1 to 3, that is, 1 to 3 in the formula (3), and is more preferably m=1 or 2. Examples of the hydrocarbon group in R³ in the formula (3) include methyl, ethyl, propyl, butyl, hexyl, and octyl, which may be branched or linear. Among these hydrocarbon groups, methyl, ethyl, propyl, and butyl are particularly preferable. Further, when two or more R² or R³ are present, all R² or R³ e optionally the same, some R² or R³ are optionally the same, or all R² or R³ are optionally different.

Preferred examples of such a silicon-containing compound (silane coupling agent) of the formula (3) include methyltrimethoxysilane, methyltriethoxysilane, methyltributoxysilane, dimethyldimethoxysilane, dimethyldiethoxysilane, dimethyldibutoxysilane, trimethylmethoxysilane, trimethylethoxysilane, n-propyltrimethoxysilane, n-propyltriethoxysilane, n-propyltributoxysilane, butyltrimethoxysilane, butyltriethoxysilane, butyltributoxysilane, dibutyldimethoxysilane, dibutyldiethoxysilane, dibutyldibutoxysilane, isobutyltrimethoxysilane, isobutyltriethoxysilane, hexyltrimethoxysilane, hexyltriethoxysilane, dihexyldimethoxysilane, dihexyldiethoxysilane, octyltrimethoxysilane, octyltriethoxysilane, dioctyldimethoxysilane, dioctyldiethoxysilane, dioctylethoxybutoxysilane, decyltrimethoxysilane, decyltriethoxysilane, didecyldimethoxysilane, didecyldiethoxysilane, octadecyltrimethoxysilane, octadecyltriethoxysilane, dioctadecyldimethoxysilane, dioctadecyldiethoxysilane, phenyltrimethoxysilane, phenyltriethoxysilane, diphenyldimethoxysilane, diphenyldiethoxysilane, trifluoropropyltrimethoxysilane, heptadecafluorodecyltrimethoxysilane, tridecafluorooctyltrimethoxysilane, tridecafluoro octyltriethoxysilane, 3-chloropropyltrimethoxysilane, 3-chloropropyltriethoxysilane, and 3-chloropropyltributoxysilane.

Examples of the reactive group capable of chemically bonding with another functional group in R⁴ in the formula (4) include a vinyl group, an epoxy group, a styryl group, a methacryloxy group, an acryloxy group, an amino group, an ureide group, a mercapto group, a polysulfide group, and an isocyanate group.

In addition, when two or more R⁴ are present, all R⁴ are optionally the same, some R⁴ are optionally the same, or all R⁴ are optionally different. The number of R⁴ in a molecule is p=1 to 3, that is, 1 to 3 in the formula (4), and is more preferably p=1.

Examples of the hydrocarbon group in R⁵ of the formula (4) include methyl, ethyl, propyl, butyl, hexyl, octyl, decyl, dodecyl, oleyl, stearyl, cyclohexyl, phenyl, benzyl, and naphthyl, which may be branched or linear, and optionally contain a halogen group such as fluorine, chlorine, or bromine. Among them, a hydrocarbon group having 1 to 18 carbon atoms is particularly preferable. In addition, when two or more R⁵ are present, they are optionally the same or different.

Examples of the hydrocarbon group in R⁶ in the formula (4) include methyl, ethyl, propyl, butyl, hexyl, and octyl, which may be branched or linear. Among these hydrocarbon groups, methyl, ethyl, propyl, and butyl are particularly preferable. In addition, when two or more R⁶ are present, all R⁶ are optionally the same, some R⁶ are optionally the same, or all R⁶ are optionally different.

Preferred examples of such a silicon-containing compound (silane coupling agent) of the formula (4) include vinyl trimethoxysilane, vinyl triethoxysilane, vinyl-tris(2-methoxyethoxy)silane, 2-(3,4-epoxycyclohexyl)ethyltrimethoxysilane, 3-glycidoxypropylmethyldiethoxysilane, 3-glycidoxypropyltrimethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-methyl-3-aminopropyl-trimethoxysilane, N-2-(aminoethyl)-3-aminopropylmethyldimethoxysilane, N-2-(aminoethyl)-3-aminopropylmethyldimethoxysilane, N-2-(aminoethyl)-3-aminopropylmethyldiethoxysilane, 3-aminopropyltrimethoxysilane, 3-aminopropyltriethoxysilane, N-phenyl-3-aminopropyltrimethoxysilane, N-(vinyl benzyl)-2-aminoethyl-3-aminopropyltrimethoxysilane, 3-triethoxysilyl-N-(1,3-dimethyl-butylidene)propylamine, 3-ureidepropyltriethoxysilane, 3-mercaptopropylmethyldimethoxysilane, 3-mercaptopropyltrimethoxysilane, 3-mercaptopropyltriethoxysilane, bis(triethoxysilylpropyl)tetrasulfide, and 3-isocyanate propyltriethoxysilane.

Examples of the hydrocarbon group in R⁷ in the formula (5) include methyl, ethyl, propyl, butyl, hexyl, octyl, decyl, dodecyl, oleyl, stearyl, cyclohexyl, phenyl, benzyl, and naphthyl, which may be branched or linear, may contain a halogen group such as fluorine, chlorine, or bromine, and may contain a heteroatom such as nitrogen, oxygen, or sulfur. Among them, a hydrocarbon group having 1 to 12 carbon atoms is particularly preferable. In addition, when two or more R⁷ are present, all R⁷ are optionally the same, some R⁷ are optionally the same, or all R⁷ are optionally different.

Preferred examples of such a silicon-containing compound (silane coupling agent) of the formula (5) include methyltrichlorosilane, dimethyldichlorosilane, trimethylchlorosilane, octyldimethylchlorosilane, phenyltrichlorosilane, vinyltrichlorosilane, and tetrachlorosilane.

When two or more of the above silicon compounds are used in combination, the reaction may be proceeded in a coexisting state, or a polysiloxane compound layer may be formed from only a silicon compound, and then another silane coupling agent may be added.

The metallic pigment composition obtained by the present invention contains a polysiloxane compound produced from the silicon-containing compound and metal particles. The polysiloxane compound in the obtained metallic pigment composition is preferably contained in an amount of 0.1 to 50 parts by mass, and more preferably 1 to 40 parts by mass in total in terms of a state where hydrolysis and condensation reaction are completed, with respect to 100 parts by mass of the metal particles. From the viewpoint of easily achieving both the storage stability of the metallic pigment composition as a paint and optical properties such as the color tone of a coating film, the polysiloxane compound is still more preferably contained in an amount of 3 to 40 parts by mass, with respect to 100 parts by mass of the metal particles, in the metallic pigment composition. This mass ratio may be even more preferably 5 to 35 parts by mass, and most preferably 7 to 35 parts by mass. By setting the content of the polysiloxane compound in the range, both the storage stability of the metallic pigment composition and the color tone of a coating film tend to be easily achieved. The thickness of the polysiloxane compound layer to be formed seems to contribute both the storage stability and the color tone of a coating film.

The amount of the polysiloxane compound to be produced derived from the alkoxysilane represented by the general formula (1) can be estimated by multiplying the mass of the alkoxysilane represented by the general formula (1) used in the production of the metallic pigment composition by the mass ratio before and after the reaction in the case where the alkoxysilane is totally hydrolyzed and subjected to the condensation reaction.

For example, when tetraethoxysilane (TEOS) is used as the alkoxysilane represented by the general formula (1), the amount of the polysiloxane compound to be produced can be estimated by using the following mass ratio before and after the hydrolysis and the condensation reaction. In addition, since the theoretical amount of water required for the reaction can be grasped from the general formula, the reaction according to stoichiometry can be substantially carried out by using an excess amount of water to the theoretical amount.

Si(OC₂H₅)₄ (molecular weight: 208)+4H₂O→Si(OH)₄ (molecular weight: 96)+(C₂H₅OH)₄ (Hydrolysis)

Si(OH)₄ (molecular weight: 96)+Si(OH)₄ (molecular weight: 96)→(SiO₂)₂ (molecular weight: 60×2)+4H₂O (Condensation)

When tetraethoxysilane is totally hydrolyzed and subjected to the condensation reaction before and after the hydrolysis and condensation reaction described above, the mass ratio is calculated to be 60/208=0.288 times. Thus, for example, when TEOS is used in an amount of 40 parts by mass with respect to 100 parts by mass of untreated metallic pigment particles, the amount of the hydrolysate and/or condensate thereof to be produced is estimated to be 0.288 times thereof, that is, 11.5 parts by mass.

With respect to the tetrahalosilane and silane coupling agents of the general formulas (2) to (5), the amount of the polysiloxane compound to be produced can be estimated in the same manner.

The content of the polysiloxane compound in the metallic pigment composition of the present invention can be quantitatively determined according to the quantitative determination method of silicon in aluminum and an aluminum alloy in accordance with the specification of JIS H1352:2007.

### <Surface Modification>

In the coating treatment step of obtaining the metallic pigment composition of the present invention, preferably before the hydrolysis and condensation reaction of the silicon-containing compound, metal particles may be subjected to surface modification using a molybdic acid, or a heteropolyanion compound or a mixed coordination type heteropolyanion compound as a surface modifier, neutralization is carried out, and then the silicon-containing compound, the catalyst, and water may be added. Through this surface modification step, coating of the surface of the metal particles by the polysiloxane compound may occur more efficiently. For example, the surface modification step can be carried out at an appropriate temperature between room temperature (about 15 to 30° C.) and 80° C. in an organic solvent dispersion of metal particles. As the organic solvent herein, the same solvents as those exemplified in the item of <Organic Solvent>can be used. The reaction time of the step is not particularly limited, but may be, for example, 5 minutes to 5 hours.

### <Surface Modifier>

Examples of the heteropolyanion compound used in the surface modification step include heteropoly acids such as H₃PMo₁₂O₄₀·nH₂O (phosphomolybdic acid n-hydrate), H₃PW₁₂O₄₀·nH₂O (phosphotungstic acid n-hydrate), H₄SiMo₁₂O₄₀·nH₂O (silicomolybdic acid n-hydrate), and H₄SiW₁₂O₄₀·nH₂O (silicotungstic acid n-hydrate), and these are preferably used (provided that, n≥0). Examples of the mixed coordination type heteropolyanion compound include mixed coordination type heteropoly acids such as H₃PWₓMo₁₂₋ₓO₄₀·nH₂O (phosphotungstomolybdic acid n-hydrate), H₃₊ₓPVₓMo₁₂₋ₓO₄₀·nH₂O (phosphovanadomolybdic acid n-hydrate), H₄SiWₓMo₁₂₋ₓO₄₀·nH₂O (silicotungstomolybdic acid n-hydrate), and H₄₊ₓSiVₓMo₁₂₋ₓO₄₀·nH₂O (silicovanadomolybdic acid n-hydrate) (provided that. 1≤x≤11 and n≥0).

### <<Reflux Step>>

In the present invention, by refluxing the metal particles coated with the polysiloxane compound obtained by the above method (coating treatment) (hereinafter, coated particles) in a hydrophilic solvent in the copresence of a basic compound and water, the structure of the polysiloxane compound layers of some particles can be changed, and the standard deviation of the surface roughness of the polysiloxane compound layer between particles can be set to 0.5 to 1.0.

The hydrophilic solvent is preferably an alcoholic solvent, and is more preferably a secondary alcohol. Specific examples thereof include isopropyl alcohol, 2-butanol, 2-pentanol, 3-pentanol, propylene glycol monomethyl ether, and propylene glycol monobutyl ether. When one having low compatibility with water is used among these alcohols, phase separation may occur therein.

The basic compound is preferably a carbonate compound containing an alkali metal. Specific examples thereof include lithium carbonate, sodium carbonate, potassium carbonate, rubidium carbonate, and cesium carbonate. The amount of the basic compound is preferably 5 mol % or more and 30 mol % or less, and more preferably 5 mol % or more and 20 mol % or less with respect to the polysiloxane compound (the amount of substance is calculated as SiO₂). When the amount of the basic compound is the lower limit of this range or more, the structure of the polysiloxane compound layer can be moderately changed. When the amount of the basic compound is the upper limit of this range or less, the peeling of the polysiloxane compound layer can be suppressed.

In addition, 1,2-dimethoxyethane, diethylene glycol dimethyl ether, triethylene glycol dimethyl ether, or the like may be added as an additive. The chelating effect of these compounds against metal ions allows the dissociation of ions to be promoted also when the water solubility of the basic compound to be used is low as in lithium carbonate, and allows the basic effect of the carbonate compound excellent in water solubility to be further enhanced.

Water is preferably added in an amount of 100 to 400 parts by mass with respect to 100 parts by mass of the contained polysiloxane compound. When an alkali metal carbonate salt is used, 1,2-dimethoxyethane is preferably added in an amount of 1 to 20 molar equivalent to the alkali metal carbonate salt. The solid content of the slurry refluxed herein is preferably 1 to 30%, and still more preferably 5 to 25%.

The temperature of the reflux step is desirably the boiling point of the hydrophilic solvent to be used. For example, when isopropyl alcohol (boiling point: 82.5° C.) is used, the set temperature of the heating layer is preferably set to about 85° C. and the conditions in which the inside of the system is maintained at 82.5° C. The reflux time may be, for example, 10 minutes to 2 hours, and preferably 20 minutes to 1 hour.

### <<Metallic Pigment Composition>>

The metallic pigment composition of the present invention obtained as mentioned above is considered to form a metallic pigment composition containing coated particles that contain metal particles (and a surface modifier, if present) and the coating made of a polysiloxane compound present on the surface of the metal particles, and a solvent such as the water/organic solvent (preferably the hydrophilic solvent) used in the production process as the residue of a solid content (nonvolatile content).

In the metallic pigment composition, the polysiloxane compound coating the metal particles is preferably contained in an amount of 0.1 to 50 parts by mass, and more preferably 1 to 40 parts by mass with respect to 100 parts by mass of the metal particles. From the viewpoint of easily achieving both the storage stability of the metallic pigment composition as a paint and optical properties such as the color tone of a coating film, the polysiloxane compound is still more preferably contained in an amount of 3 to 40 parts by mass, based on 100 parts by mass of the metal particles, in the metallic pigment composition. This mass ratio may be even more preferably 5 to 35 parts by mass, and most preferably 5 to 32 parts by mass.

In the metallic pigment composition, a surface modifier such as molybdenum acid, or a heteropolyanion compound or a mixed coordination type heteropolyanion compound that is optionally used is preferably present in an amount of 0.01 to 10 parts by mass with respect to 100 parts by mass of the metal particles.

In the metallic pigment composition, a solvent containing the water/organic solvent (preferably the hydrophilic solvent) used in the production process may be present as the residue of the above component (nonvolatile content). The amount of the solvent containing the water/organic solvent may be, for example, 10 to 150% by mass of the metallic pigment composition. Alternatively, the amount of the solvent containing the water/organic solvent may be 10 to 140% by mass, 15 to 130% by mass, or 20 to 130% by mass of the metallic pigment composition.

The metallic pigment composition obtained by the production method of the present invention can be used for an organic solvent-based paint, ink, or the like. In this case, a metallic aqueous paint or metallic aqueous ink can be made by adding the metallic pigment composition obtained by the production method of the present invention to an aqueous paint or aqueous ink in which a resin that is a coating film-forming component is dissolved or dispersed in a medium mainly containing water. The metallic pigment composition obtained by the production method of the present invention can be used as a water resistant binder or filler by being kneaded with a resin and the like. For example, an optional additive such as an antioxidant, a light stabilizer, a polymerization inhibitor, or a surfactant may be added when the metallic pigment composition is blended with an aqueous paint, an aqueous ink, a resin, or the like.

When the metallic pigment composition obtained by the production method of the present invention is used for a paint or an ink, it may be added to an (aqueous) paint or an (aqueous) ink as it is, and is preferably dispersed in a solvent in advance and then added. Examples of the solvent used in this case include water, texanol, diethylene glycol monobutyl ether, and propylene glycol monomethyl ether. Examples of the above resin include acrylic resins, polyester resins, polyether resins, epoxy resins, fluorine resins, and rosin resins.

The content of the metallic pigment composition according to the present invention in the above paint or ink is typically only required to be 0.1 to 50% by mass, and particularly preferably 1 to 30% by mass, without limitation. When the content is 0.1% by mass or more, a high decorative (metallic) effect can be obtained. In addition, when the content is 50% by mass or less, the characteristics such as weather resistance, corrosion resistance, and machine strength of the aqueous paint or aqueous ink may be prevented from being impaired. The content of the solvent in this case is not particularly limited, and may be 20 to 200% by mass with respect to the resin binder content. When the content of the solvent is within this range, the viscosity of the paint or ink is adjusted to an appropriate range, and handling and film formation may be easy.

Examples of the acrylic resin include acrylic resins obtained by polymerizing one or a mixture selected from (meth)acrylic acid esters such as (meth)methyl acrylate, (meth)ethyl acrylate, (meth)isopropyl acrylate, n-butyl (meth)acrylate, 2-ethylhexyl (meth)acrylate, and lauryl (meth)acrylate; (meth)acrylic acid esters having an active hydrogen such as 2-hydroxyethyl (meth)acrylate, 2-hydroxypropyl (meth)acrylate, 2-hydroxybutyl (meth)acrylate, 3-hydroxypropyl (meth)acrylate, and 4-hydroxybutyl (meth)acrylate; unsaturated carboxylic acids such as acrylic acid, methacrylic acid, maleic acid, and itaconic acid; unsaturated amides such as acrylamide, N-methylolacrylamide, and diacetone acrylamide; and other polymerizable monomers such as glycidyl methacrylate, styrene, vinyl toluene, vinyl acetate, acrylonitrile, dibutyl fumarate, p-styrene sulfonic acid, and allyl sulfosuccinic acid.

As the polymerization method thereof, emulsion polymerization is typically used, and the acrylic resin can also be produced by suspension polymerization, dispersion polymerization, or solution polymerization. In the emulsion polymerization, polymerization may be carried out in a stepwise manner.

Examples of the polyester resin include polyester resins obtained by condensation reaction between one or a mixture selected from the group consisting of carboxylic acids such as succinic acid, adipic acid, sebacic acid, dimer acid, maleic anhydride, phthalic anhydride, isophthalic acid, terephthalic acid, trimellitic acid, and pyromellitic acid, and a polyhydric alcohol alone or a mixture of polyhydric alcohols selected from the group consisting of diols such as ethylene glycol, diethyleneglycol, triethylene glycol, propylene glycol, dipropylene glycol, tripropylene glycol, 1,2-propanediol, 1,3-propanediol, 1,2-butanediol, 1,3-butanediol, 1,4-butanediol, 2,3-butanediol, 2-methyl-1,2-propanediol, 1,5-pentanediol, 2-methyl-2,3-butanediol, 1,6-hexanediol, 1,2-hexanediol, 2,5-hexanediol, 2-methyl-2,4-pentanediol, 2,3-dimethyl-2,3-butanediol, 2-ethyl-hexanediol, 1,2-octanediol, 1,2-decanediol, 2,2,4-trimethylpentanediol, 2-butyl-2-ethyl-1,3-propanediol, and 2,2-diethyl-1,3-propanediol, triols such as glycerin and trimethylol propane, and tetraols such as diglycerin, dimethylolpropane, and pentaerythritol; and polycaprolactones obtained by, for example, ring-opening polymerization of a hydroxy group of a low molecular weight polyol with E-caprolactone.

Examples of the polyether resin include polyether polyols obtained by adding an alkylene oxide alone or a mixture of alkylene oxides such as ethylene oxide, propylene oxide, butylene oxide, cyclohexene oxide, and styrene oxide to a polyvalent hydroxy compound or a mixture of polyvalent hydroxy compounds using a hydroxide such as lithium, sodium, or potassium, or a strongly basic catalyst such as alkoxide or alkylamine; and further, polyether polyols obtained by reacting a polyfunctional compound such as ethylenediamine with an alkylene oxide; polyether polyols obtained by ring-opening polymerization of a cyclic ether such as tetrahydrofuran; and so-called polymer polyols obtained by polymerizing acrylamide or the like using these polyethers as the medium. These resins are preferably emulsified, dispersed, or dissolved in water. The carboxyl group, sulfonyl group, or the like contained in the resin may be neutralized for emulsification, dispersion, or dissolution in water.

As the neutralizer for neutralizing the carboxyl group, sulfonyl group, or the like, one or more selected from ammonia and water soluble amino compounds such as monoethanolamine, ethylamine, dimethylamine, diethylamine, triethylamine, n-propylamine, di-n-propylamine, isopropylamine, diisopropylamine, triethanol amine, butylamine, dibutylamine, 2-ethylhexylamine, ethylenediamine, propylenediamine, methyl ethanol amine, dimethyl ethanol amine, diethyl ethanol amine, and morpholine may be used. Preferred examples of the neutralizer include triethylamine and dimethyl ethanol amine which are tertiary amines.

The preferred resin is an acrylic resin or a polyester resin. A resin such as a melamine curing agent, an isocyanate curing agent, or a urethane dispersion may be used in combination, as needed. Further, these resins may be combined with an inorganic pigment, an organic pigment, an extender pigment, a silane coupling agent, a titanium coupling agent, a dispersing agent, an anti-settling agent, a leveling agent, a thickening agent, or a defoaming agent typically added to paint. To improve the dispersibility of the resin into the paint, a surfactant may be further added. To improve the storage stability of the paint, an antioxidant, a light stabilizer, and a polymerization inhibitor may be further added.

### EXAMPLES

Hereinafter, the present invention will be described in more detail with reference to Examples and Comparative Examples of the present invention. The following Examples are described for illustrative purposes, and are not intended to limit the present invention in any way.

### Example 1

After 135 g of a commercially available aluminum paste (trade name “GX-4100” (average particle size d50: 10 μm, nonvolatile content: 74%) manufactured by Asahi Kasei Corporation) was dispersed in 103 g of propylene glycol monomethyl ether, 0.5 g of a hydrate of phosphotungstic molybdic acid (H₃PW₆Mo₆O₄₀) was added, and the slurry was stirred for 1 hour while maintaining the slurry temperature at 50° C. 0.2 g of 28% ammonia water was added for neutralization, and then, 69.4 g of tetraethoxysilane (abbreviated as TEOS in Table) was added as alkoxysilane. Thereafter, 108 mg of cesium carbonate was dissolved in 24 g of water as a catalyst and then added to the slurry, followed by stirring for 2 hours. After the reaction was terminated, the slurry was cooled to room temperature and filtrated to obtain 240 g of an aluminum pigment composition having a nonvolatile content of 50%.

### Example 2

An aluminum pigment composition having a nonvolatile content of 50% was obtained in the same manner as in Example 1, except that 0.1 g of 3-aminopropyltrimethoxysilane (abbreviated as APTMS in Table) was added 2 hours after the addition of the aqueous cesium carbonate solution and stirred for 2 hours.

### Example 3

An aluminum pigment composition having a nonvolatile content of 50% was obtained in the same manner as in Example 1, except that the tetraethoxysilane added was 138.9 g, the sodium carbonate added was 70.6 mg, and the water added was 47.9 g.

### Example 4

An aluminum pigment composition having a nonvolatile content of 50% was obtained in the same manner as in Example 1, except that the tetraethoxysilane added was 13.9 g, the cesium carbonate added was 217 mg, and the water added was 4.8 g.

### Example 5

An aluminum pigment composition having a nonvolatile content of 50% was obtained in the same manner as in Example 1, except that the tetraethoxysilane added was 34.7 g, the cesium carbonate added was 542 mg, and the water added was 12 g.

### Example 6

An aluminum pigment composition having a nonvolatile content of 50% was obtained in the same manner as in Example 1, except that 50.7 g of tetramethoxysilane (abbreviated as TMOS in Table) was used as the alkoxysilane added, the cesium carbonate added was 108 mg, and the water added was 6 g.

### Example 7

An aluminum pigment composition having a nonvolatile content of 50% was obtained in the same manner as in Example 1, except that 132 g of tetra-n-propoxysilane (abbreviated as TPOS in Table) was used as the alkoxysilane added, the cesium carbonate added was 16.3 g, and the water added was 36 g.

### Example 8

An aluminum pigment composition having a nonvolatile content of 50% was obtained in the same manner as in Example 1, except that 132 g of tetraisopropoxysilane (abbreviated as TIPOS in Table) was used as the alkoxysilane added, the cesium carbonate added was 16.3 g, and the water added was 36 g.

### Example 9

240 g of an aluminum pigment composition obtained in the same manner as in Example 1 was dispersed in 467 g of isopropyl alcohol. Thereafter, 4.6 g of potassium carbonate as a catalyst and 3.0 g of 1,2-dimethoxyethane were dissolved in 60 g of water and then added to the slurry, and the slurry was refluxed at 90° C. for 30 minutes. After the reaction was terminated, the slurry was cooled to room temperature and filtrated to obtain an aluminum pigment composition having a nonvolatile content of 50%.

### Example 10

An aluminum pigment composition having a nonvolatile content of 50% was obtained by subjecting 280 g of an aluminum pigment composition obtained in the same manner as in Example 3 to reflux treatment in the same manner as in Example 9, except that potassium carbonate was 9.2 g, 1,2-dimethoxyethane was 6.0 g, and water was 120 g.

### Example 11

An aluminum pigment composition having a nonvolatile content of 50% was obtained by subjecting 208 g of an aluminum pigment composition obtained in the same manner as in Example 4 to reflux treatment in the same manner as in Example 9, except that potassium carbonate was 920 mg, 1,2-dimethoxyethane was 600 mg, and water was 12 g. In the reflux treatment conditions in Examples 9 to 11 and Comparative Examples 2 and 4, potassium carbonate is 10 mol % with respect to Si, in each case.

### Comparative Example 1

465 g of isopropyl alcohol was added to 135 g of a commercially available aluminum paste (trade name “GX-4100 (average particle size: 10.5 μm, nonvolatile content: 74%)” manufactured by Asahi Kasei Corporation). While stirring the dispersed slurry, a solution in which 1.0 g of a hydrate of phosphotungstic molybdic acid (H₃PW₆Mo₆O₄₀) was dissolved in 5 g of isopropyl alcohol was gradually added thereto and stirred for 1 hour while maintaining the slurry temperature at 40° C. Thereafter, 10 g of tetraethoxysilane was added as alkoxysilane, and then 10 g of 25% ammonia water and 200 g of purified water was added over 3 hours. Thereafter, 1.23 g of methyltrimethoxysilane (abbreviated as MTMS in Table) was further added as a silane coupling agent, and the slurry was stirred for 2 hours. After the reaction was terminated, the slurry was cooled and then filtrated to obtain an aluminum pigment composition having a nonvolatile content of 50%.

### Comparative Example 2

An aluminum pigment composition having a nonvolatile content of 50% was obtained by subjecting 207 g of an aluminum pigment composition obtained in the same manner as in Comparative Example 1 to reflux treatment in the same manner as in Example 11.

### Comparative Example 3

500 mg of metal molybdenum powder was added to 10 g of a 30% hydrogen peroxide solution, which was then dissolved in 600 g of isopropyl alcohol. Then, 135 g of commercially available aluminum paste (trade name “GX-4100 (average particle size: 10.5 μm, nonvolatile content: 74%)” manufactured by Asahi Kasei Corporation) was added, and the slurry was stirred at 50° C. for 1 hour. Thereafter, monoethanolamine was added until the pH of the slurry reached 8.5. Then, 40 g of tetraethoxysilane was added as alkoxysilane, and the slurry was stirred for 10 hours while maintaining the pH at 8.5. After the reaction was terminated, the slurry was filtrated and dried at 105° C. for 3 hours to obtain a powdery aluminum pigment.

### Comparative Example 4

An aluminum pigment composition having a nonvolatile content of 50% was obtained by subjecting 110 g of the powdery aluminum pigment obtained in the same manner as in Comparative Example 3 to reflux treatment in the same manner as in Example 9 except that the powdery aluminum pigment was dispersed in 540 g of isopropyl alcohol, and potassium carbonate was 2.3 g, 1,2-dimethoxyethane was 1.5 g, and water was 30 g.

### Comparative Example 5

An aluminum pigment composition having a nonvolatile content of 50% was obtained in the same manner as in Example 1, except that the cesium carbonate added was 36.9 g.

### Height Image and Bird's-Eye View by AFM

The measurement was carried out by cleaning a sample with hexane, and then attaching the sample to a silicon wafer surface. The measurement field of view was set to 2 μm, 512 pixels. The measurement field of view was divided into 16 divisions, three-dimensional correction (Plane Fit) was carried out on each division, and then Ra values were calculated. The minimum value in 16 divisions was taken as Ra derived from the polysiloxane compound layer, and an average value of 20 fields of view was calculated for each sample.

### <Measurement Conditions>

Apparatus: Bruker Dimension Icon
Measurement mode: QNM in Air
Probe: SCANASYST-AIR (k=0.4 N/m, ozone cleaned one was used)
Measurement field of view: 2 μm/512×512 pixels

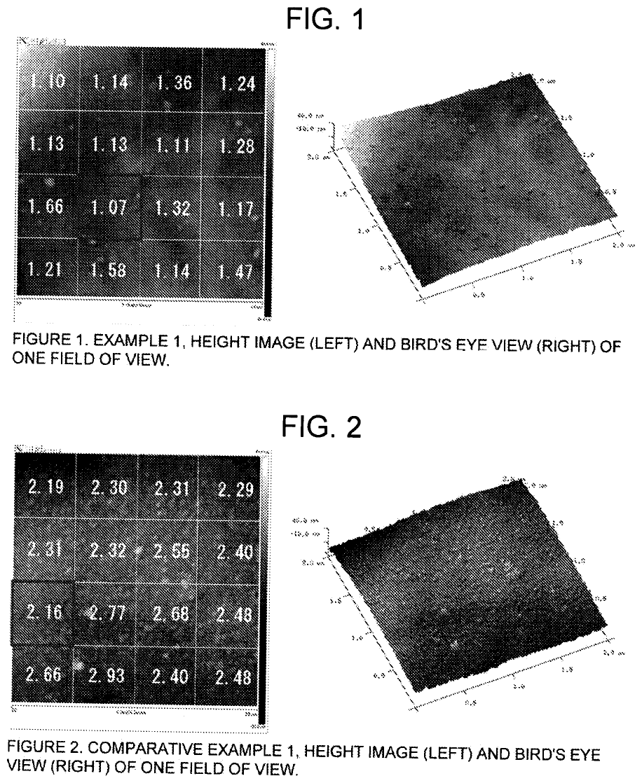

Each of FIG. 1 and FIG. 2 illustrates a height image and a bird's-eye view of one field of view of each sample obtained in Example 1 and Comparative Example 1 observed by AFM as representative examples. The value (the minimum value) of a division surrounded by a bold frame in the height image in the figures (in FIG. 1, a bold frame surrounding “1.07”, and in FIG. 2, a bold frame surrounding “2.16”) was taken as Ra derived from the polysiloxane compound layer in the particle and used in the calculation of the average value.

### [Evaluation 1 (Evaluation of Water Resistance (Gas Generation))]

20 g of the obtained aluminum pigment composition (nonvolatile content: 10 g) was collected in a flask and made into a slurry with 200 g of water. Thereafter, for one obtained by adding an appropriate amount of 0.1 mol/L hydrochloric acid to the slurry to adjust the pH to 5.0, and one obtained by adding an appropriate amount of a 10% dimethylaminoethanol aqueous solution to the slurry to adjust the pH to 9.0, the amount of accumulated hydrogen gas generation was observed in a thermostat water bath at 60° C. until 24 hours. The evaluation was made as follows according to the amount of gas generation and used as the index of the water resistance of the aluminum pigment composition.
⊚: 0 mL within the experimental error range (± about 0.5 mL)
◯: less than 1.5 mL
Δ: 1.5 mL or more and less than 3.0 mL
x: 3.0 mL or more and less than 20 mL
xx: 20 mL or more

### [Evaluation 2 (Water Dispersibility Evaluation: Difference in Particle Diameter Before and After Treatment)]

10 mg of the obtained aluminum pigment composition was dispersed in purified water (50 g) and subjected to ultrasonic irradiation for 2 minutes, and then, the particle size distribution was measured by using a laser diffraction particle size distribution measurement apparatus LA-300 manufactured by Horiba, Ltd. using a batch cell at a transmittance of 80 to 90%, and the numerical value of d50 was taken as the average particle size. The change of d50 from the aluminum paste (trade name “GX-4100” (average particle size d50: 10.5 μm) manufactured by Asahi Kasei Corporation) before the hydrophilization treatment was evaluated in Table as follows: “particle diameter in water after treatment−particle diameter before treatment”.

With respect to the particle diameter before treatment, the aluminum paste before treatment was dispersed in a mineral spirit (50 g) suitable for dispersion, the resulting slurry was subjected to ultrasonic irradiation for 2 minutes, and then a numerical value measured by the above measurement method was used.
⊚: less than +0.5 μm
◯: +0.5 μm or more and less than +1.0 μm
Δ: +1.0 μm or more and less than +2.0 μm
x: +2.0 μm or more

### [Preparation of Aqueous Metallic Paint]

An aqueous metallic paint having the following components was prepared.
Aluminum pigment composition: 5.0 g as a nonvolatile content
Purified water: 45.0 g
Water soluble acrylic resin (*1): 40.0 g
1: WATERSOL S744 manufactured by DIC Corporation

After the above components were mixed, the pH was adjusted to 9.0 to 9.1 with dimethylethanol amine, and the viscosity was adjusted to 650 to 750 mPa s (B TYPE VISCOMETER, No. 3 rotor, 60 revolutions, 25° C.) with a carboxylic acid thickening agent and purified water. Using the prepared aqueous metallic paint, the following evaluation was carried out.

### [Evaluation 3 (Coating Film Color Tone Evaluation)]

### Luminance

The above aqueous metallic paint was air-spray coated to an intermediate coated steel sheet of 12 cm×6 cm so as to have a dry film thickness of 15 μm and dried at room temperature for 20 minutes to prepare a coated sheet.

An organic solvent-type top coat paint was prepared by mixing and dispersing the following components with a spatula for 3 to 4 minutes, and then adjusting the paint viscosity to 20.0 seconds using Ford cup No. 4.
A345 (acrylic clear resin manufactured by DIC Corporation) 420 g
L-117-60 (melamine resin manufactured by DIC Corporation) 165 g
SOLVESSO 100 (aromatic solvent manufactured by Exxon Mobil Chemical Company) 228 g

Using a laser-type metallic feeling measuring apparatus, Alcope LMR-200 manufactured by KANSAI PAINT CO., LTD., the luminance of the coating film was evaluated. Optical conditions were such that a laser light source was provided at an incidence angle of 450 and receivers were provided at light receiving angles of 0° and −35°. As the measured value, an IV value was determined at a light-receiving angle of −35° at which the maximum light intensity is obtained among reflected lights of the laser, except for the light of a specular reflection area reflecting on the coating film surface. The IV value is a parameter proportional to the intensity of the regular reflection light from the coating film, and represents the magnitude of brightness. The determination method is as follows.
⊚: IV value is 320 or more
◯: IV value is 280 or more and less than 320
x: IV value is less than 280

TABLE 1
[Coating treatment conditions]

| | | | | | Water/silicon- |
|---|---|---|---|---|---|
| | | | | Catalytic | containing |
| | Silicon-containing | | | amount | compound |
| | compound (g) | | Catalyst | (mol %) | (molar ratio) |
| Example 1 | TEOS | 69.4 | Cesium carbonate | 0.1 | 4 |
| Example 2 | TEOS + | 69.5 | Cesium carbonate | 0.1 | 4 |
| | APTMS | | | | |
| Example 3 | TEOS | 138.7 | Sodium carbonate | 0.1 | 4 |
| Example 4 | TEOS | 13.9 | Cesium carbonate | 1.0 | 4 |
| Example 5 | TEOS | 34.7 | Cesium carbonate | 1.0 | 4 |
| Example 6 | TMOS | 50.7 | Cesium carbonate | 0.1 | 1 |
| Example 7 | TPOS | 132 | Cesium carbonate | 10 | 4 |
| Example 8 | TIPOS | 132 | Cesium carbonate | 20 | 4 |
| Comparative | TEOS + | 11.2 | Ammonia | 250 | 200 |
| Example 1 | MTMS | | | | |
| Comparative | TEOS | 40 | Monoethanolamine | — | 2 |
| Example 3 | | | | | |
| Comparative | TEOS | 69.4 | Cesium carbonate | 34 | 4 |
| Example 5 | | | | | |

TABLE 2
[Reflux treatment conditions]

| | Reflux | | | 1,2-Dimethoxyethane | Water |
|---|---|---|---|---|---|
| | pretreatment | Basic catalyst (g) | | (g) | (g) |
| Example 9 | Example 1 | Potassium carbonate | 4.6 | 3 | 60 |
| Example 10 | Example 3 | Potassium carbonate | 9.2 | 6 | 120 |
| Example 11 | Example 4 | Potassium carbonate | 0.92 | 0.6 | 12 |
| Comparative | Comparative | Potassium carbonate | 0.92 | 0.6 | 12 |
| Example 2 | Example 1 | | | | |
| Comparative | Comparative | Potassium carbonate | 2.3 | 1.5 | 30 |
| Example 4 | Example 3 | | | | |

TABLE 3
[Evaluation results]

| | Polysiloxane | | | | | | |
|---|---|---|---|---|---|---|---|
| | compound | AFM measurement | | Water resistance | | | |
| | (parts by mass) | results | | (gas generating | | | |
| | with respect to | Surface | Standard | properties) | | | |
| | 100 parts by mass | roughness | deviation | Acidic | Basic | Water | Color |
| | of metal particles | Ra (nm) | σ | pH 5 | pH 9 | dispersibility | tone |
| Example 1 | 20 | 1.13 | 0.06 | ⊚ | ⊚ | ◯ | ⊚ |
| Example 2 | 20 | 1.22 | 0.02 | ⊚ | ⊚ | ◯ | ⊚ |
| Example 3 | 40 | 1.23 | 0.18 | ⊚ | ⊚ | ◯ | ◯ |
| Example 4 | 4 | 0.96 | 0.13 | ◯ | ◯ | ◯ | ⊚ |
| Example 5 | 10 | 1.31 | 0.19 | ◯ | ◯ | ◯ | ⊚ |
| Example 6 | 20 | 1.82 | 0.27 | ◯ | ◯ | ◯ | ⊚ |
| Example 7 | 30 | 0.72 | 0.07 | ⊚ | ⊚ | ◯ | ◯ |
| Example 8 | 30 | 0.70 | 0.02 | ⊚ | ⊚ | ◯ | ◯ |
| Example 9 | 20 | 1.87 | 0.78 | ◯ | ◯ | ⊚ | ⊚ |
| Example 10 | 40 | 1.99 | 0.86 | ◯ | ◯ | ⊚ | ⊚ |
| Example 11 | 4 | 1.61 | 0.53 | ◯ | ◯ | ⊚ | ⊚ |
| Comparative | 4 | 2.40 | 0.25 | Δ | ◯ | Δ | Δ |
| Example 1 | | | | | | | |
| Comparative | 4 | 3.14 | 0.51 | X | Δ | X | Δ |
| Example 2 | | | | | | | |
| Comparative | 12 | 2.54 | 0.33 | X | ◯ | Δ | Δ |
| Example 3 | | | | | | | |
| Comparative | 12 | 3.23 | 1.53 | X | Δ | X | Δ |
| Example 4 | | | | | | | |
| Comparative | 20 | 1.92 | 1.04 | X | X | X | X |
| Example 5 | | | | | | | |

In Comparative Example 5, a large amount of metal particles having no polysiloxane compound layer on the surface, that is, uncoated aluminum particles were contained. Although the surface roughness Ra was 2.0 or less, uncoated aluminum particles resulted in inferior water resistance, water dispersibility, and color tone.

### INDUSTRIAL APPLICABILITY

According to the present invention, there is provided a metallic pigment composition that is usable for, for example, a paint composition or an ink composition, in particular, an aqueous paint or an aqueous ink, is excellent in the storage stability as the paint and the like, is also excellent in optical properties such as brightness and hiding properties when used as a coating film, and has excellent optical properties and water dispersibility. Therefore, the metallic pigment composition of the present invention has a practically high value, and can be suitably used in the production of paint and ink and in wide industrial fields such as automobiles, home appliances, and printing.

1. A metallic pigment composition comprising metal particles whose surface is coated with a polysiloxane compound, wherein a surface roughness Ra when roughness of a polysiloxane compound layer present on the surface of the particles is evaluated by AFM is 0.0 to 2.0 nm.

2. The metallic pigment composition comprising metal particles whose surface is coated with a polysiloxane compound according to claim 1, wherein a standard deviation of average values when roughness of the polysiloxane compound layer present on the surface of the particles is evaluated by AFM for 20 particles is 1.0 or less.

3. The metallic pigment composition according to claim 1, wherein the polysiloxane compound coating the surface of the metal particles is present in an amount of 0.1 to 50 parts by mass with respect to 100 parts by mass of the metal particles, in the metallic pigment composition.

4. The metallic pigment composition according to claim 1, wherein a silicon-containing compound forming the polysiloxane compound layer is at least one selected from the group consisting of alkoxysilane represented by the following general formula (1), tetrahalosilane represented by the following general formula (2), silane coupling agents of the following general formulas (3) to (5), and a partial condensate thereof:
Si(OR¹)₄ (1)
wherein R¹ is a hydrogen atom or a hydrocarbon group having 1 to 8 carbon atoms, and all R¹ are optionally the same, some R¹ are optionally the same, or all R¹ are optionally different;
SiX¹₄ (2)
wherein X¹ is any one of a fluorine atom, a chlorine atom, a bromine atom, and an iodine atom, and all X¹ are optionally the same, some X¹ are optionally the same, or all X¹ are optionally different;
R²ₘSi(OR³)₄₋ₘ (3)
wherein R² is a hydrogen atom or a hydrocarbon group having 1 to 30 carbon atoms and optionally containing a heteroatom or a halogen group, R³ is a hydrogen atom or a hydrocarbon group having 1 to 8 carbon atoms; R² and R³ are optionally the same or different; all R² or R³ are optionally the same, some R or R³ are optionally the same, or all R² or R³ are optionally different when two or more R² or R³ are present; and 1≤m≤3 is satisfied;
R⁴ₚR⁵_{q}Si(OR⁶)_{4-p-q} (4)
wherein R⁴ is a group containing a reactive group capable of chemically bonding with another functional group, R⁵ is a hydrogen atom or a hydrocarbon group having 1 to 30 carbon atoms and optionally containing a halogen group, and R⁶ is a hydrogen atom or a hydrocarbon group having 1 to 8 carbon atoms; all R⁴, R⁵, or R⁶ are optionally the same, some R⁴, R⁵, or R⁶ are optionally the same, or all R⁴, R⁵, or R⁶ are optionally different when two or more R⁴, R⁵, or R⁶ are present; and 1≤p≤3, 0≤q≤2, and 1≤p+q≤3 are satisfied; and
R⁷ᵣSiX²₄₋ᵣ (5)
wherein R⁷ is a hydrogen atom or a hydrocarbon group having 1 to 30 carbon atoms and optionally containing a heteroatom or a halogen group, R⁷ are optionally the same or different, and all R⁷ are optionally the same, some R⁷ are optionally the same, or all R⁷ are optionally different when two or more R⁷ are present; 1≤r≤3 is satisfied; X² is any one of a fluorine atom, a chlorine atom, a bromine atom, and an iodine atom, and all X² are optionally the same, some X² are optionally the same, or all X² are optionally different when two or more X² are present.

5. A method for producing the metallic pigment composition according to claim 1, comprising subjecting a silicon-containing compound to hydrolysis and condensation reaction in an organic solvent with a carbonate compound having a solubility in 100 g of water at ordinary temperatures of 20 g/100 g water or more in an amount of 0.1 mol % or more and 30 mol % or less based on the silicon-containing compound to obtain a polysiloxane compound, and coating the surface of metal particles with the obtained polysiloxane compound.

6. A method for producing the metallic pigment composition according to claim 1, comprising subjecting the metal particles coated with the polysiloxane compound to reflux treatment in a hydrophilic solvent in the copresence of a basic compound and water.

7. The method for producing the metallic pigment composition according to claim 5, comprising subjecting the metal particles coated with the obtained polysiloxane compound to reflux treatment in a hydrophilic solvent in the copresence of a basic compound and water.
